(19) United States
(12) Patent Application Publication
(10) Pub. No.: US 2013/0206651 A1
(43) Pub. Date: Aug. 15, 2013

(54) METHOD AND DEVICE FOR SORTING

(71) Applicant: Reinhold Huber, Fuerstenfeld (AT)

(72) Inventor: Reinhold Huber, Fuerstenfeld (AT)

(73) Assignee: BINDER + CO AG, Gleisdorf (AT)

(21) Appl. No.: 13/824,521

(22) PCT Filed: Dec. 20, 2011
(86) PCT No.: PCT/EP11/73405

§ 371 Date: Apr. 17, 2013

(30) Foreign Application Priority Data
Dec. 20, 2010 (AT) GM 771/2010

(51) Int. Cl. B07C 5/34; B07C 5/36

(52) U.S. Cl. CPC B07C 5/34; B07C 5/366
USPC 209/567; 209/552; 209/580; 209/587; 209/588; 209/586; 209/571; 209/577

(57) ABSTRACT

A method for sorting out interfering objects (2) in a material stream (13) consisting of acceptable material (1), preferably cullet, wherein during a sorting process the interfering objects (2) and the acceptable material (1) are respectively sorted in at least one separate room area or container, preferably a shaft (9, 10). In order to achieve high degrees of purity with low loss of acceptable material and to simultaneously avoid the use of high fluid blowout pressures and quantities, it is provided that the material stream (13) is continuously subjected during a sorting process to a fluid stream, preferably consisting of compressed air, having a blowing pressure, wherein the fluid stream is interrupted temporally and/or locally depending on a detection result of a detection device (14), which detects the interfering objects in the material stream (13).

### BACKGROUND OF THE INVENTION

The present invention relates to a method for sorting out interfering objects in a material stream consisting of acceptable material, preferably cullet, wherein the interfering objects and the acceptable material are respectively sorted during a sorting process in at least one separate room area or a container, preferably a shaft.

The present invention also relates to an apparatus for sorting out interfering objects in a material stream consisting of acceptable material, preferably cullet, comprising at least one blowing apparatus with at least one blowing opening, a detecting apparatus and separate room areas or containers, preferably shafts, for receiving or transmitting the interfering objects or the acceptable material.

### DESCRIPTION OF THE PRIOR ART

In the case of sensor-supported sorting of bulk materials such as waste glass, industrial materials etc, interfering objects (foreign bodies and objects to be sorted out) are usually actively ejected out of a material stream consisting of objects by means of fluid pulses in a locally and temporally correct manner. For this purpose, NC valves (“normally closed”, i.e. closed without current) are used which activate a fluid flow and are triggered by a control unit accordingly. The control unit will be supplied on its part by at least one detecting apparatus, which detects interfering objects in the material stream preferably by means of optical or inductive transmitters and receivers.

Such a sorting apparatus is known from AT 395545 B for example. The transmitters consist for example of light sources, preferably diode light sources, which emit light rays that are concentrated in the receivers via a lens system to a photocell. Both the transmitter and also the receiver are connected to a central control unit which processes the incoming data and allows detecting the position, size and type of the objects situated in the material stream on the basis of the intensity of the light rays impinging on the receiver and emitted by the transmitters.

Sorting is subsequently performed depending on the occurred detection of the interfering objects in the material stream. It usually occurs by blowing out the interfering objects by means of a fluid during their free fall or during their transport on a link conveyor through the gaps of the link belt, by means of which the interfering objects are deflected from their path of flight or from the material stream resting on the link conveyor into a container provided for this purpose. Especially when the interfering objects are heavy or have a high weight per unit area (ratio of mass and area, which is also known as mass per unit area) and/or show a geometrically unfavourable shape, as is the case for example with stones or bottle stoppers, a high pulse force is required and therefore a high blowing pressure of the fluid or a high fluid quantity in order to ensure successful blowing out. Compressed air is typically used as a fluid, which is why compressed air will be mentioned below at all times as an example.

Such systems are used for example as interfering material or interfering object separators in the preparation of waste glass or cullet, which also includes such with a high fraction of interfering objects, e.g. with a quantity of ceramic, stone or porcelain objects (CSP) of more than 5% of the material stream. In this case, a limited degree of purity has been noticed, i.e. the fraction of interfering objects that are sorted out (relating to the total quantity of interfering objects) of typically less than 97% and a relatively high loss of acceptable material, i.e. the fraction of acceptable glass of up to 25% that is erroneously sorted out. This is accompanied by a high consumption of compressed air. If one considers the rising quality requirements of the glassworks placed on the cullet supplied for recycling (typically a maximum of 25 ppm of ceramic, stone or porcelain objects (CSP) are accepted in the cullet), it will become clear that multi-step sorting processes with four sorting steps (i.e. with four sorting apparatuses switched successively) need to be used.

In order to achieve higher degrees of purity, the acceptable material can alternatively be blown out, by means of which high purities can be achieved, i.e. high qualities of the cullet after sorting such as the aforementioned 25 ppm content of interfering objects. In view of a typical acceptable material fraction of 95% or more in the cullet material stream to be sorted, this means relating to the nominal feed performance (e.g. 10 metric tons per hour relating to a sorting or material stream width of 1 m) up to 1000 switching pulses/min of the NC valves. This places an enormous burden on the NC valves and leads to a drastic reduction in the operational lifespan of the mechanical and electrical valves. The consumption of compressed air is also disadvantageous, which can increase up to the maximum flow rate of the feed lines. In order to prevent an imminent system collapse which is promoted by the enormous overpressure and the occurring swirling in the separation chamber, such sorting apparatuses that operate in this manner are usually only operated with strongly reduced feed performance which is approximately one-third of the nominal feed performance, which represents a serious economic disadvantage. In order to nevertheless achieve the predetermined feed performances, parallel sorting processes by using many sorting apparatuses are often necessary.

### OBJECT OF THE INVENTION

It is therefore the object of the present invention to provide a method for sorting a material stream and an apparatus for performing the method which avoid the aforementioned disadvantages and ensure a high degree of purity in combination with low loss of acceptable material and therefore high purities.

### SUMMARY OF THE INVENTION

This is achieved in accordance with the invention in such a way that for the purpose of sorting a material stream it is subjected continuously to a fluid flow, preferably compressed air. The blowing already leads to a certain sorting effect because the objects of the material stream will be deflected into a separation chamber depending on their weight per unit area and/or their geometrical shape. Accordingly, trajectories of interfering objects with high weight per unit area will hardly be influenced because interfering objects with high weight per unit area will hardly be deflected. Acceptable material with a low or middle weight per unit area for example will be deflected to a considerable extent, which is why the associated trajectories will deviate from those of the interfering objects with high weight per unit area. Final sorting will be achieved in that interfering objects will be identified and the blowing will be interrupted in a purposeful manner. A clearer separation of the trajectories will be achieved in this manner.

It is specifically provided in a method for sorting out interfering objects in a material stream of acceptable material, preferably cullet, wherein the interfering objects and the acceptable material are respectively sorted during a sorting process into at least one separate room area or a container, preferably a shaft, that the material stream will continuously be subjected during a sorting process to a fluid flow having a blowing pressure, preferably consisting of compressed air, wherein the fluid flow will be interrupted temporally and/or locally depending on a detection result of a detection apparatus which detects the interfering objects in the material flow. The fluid flow will be blown from a blowing apparatus. The blowing apparatus comprises at least one blowing opening from which the fluid flow will emit.

In a preferred embodiment of the method, the individual objects of the material stream are in free fall, i.e. the material stream will be blown during its free fall.

It is provided in a further preferred embodiment of the method in accordance with the invention that the blowing pressure of the fluid flow is temporally substantially constant.

In order to subject the material stream to blowing in a homogeneous manner over its entire width, it is further provided that the blowing pressure of the fluid flow is substantially constant over the width of the material stream.

Although the method in accordance with the invention has a permanent compressed-air consumption in comparison with blowing methods as known from the state of the art, the total consumption of compressed air relating to the sorting quantity (i.e. relating to the quantity of objects of the material stream to be sorted) is substantially lower. This is especially due to the considerably lower blowing pressure of typically 2.5 to 4.0 bars, especially preferably 3.5 bars. Conventional blowing methods as described above operate on the other hand with substantially higher blowing pressures of usually approximately 6 bars. The blowing pressure shall be understood as being the pressure which is measured directly at the respective blowing opening.

The detection of at least one virtually random material property can be used as a criterion for the identification of the individual objects of the material stream, especially the interfering objects. It is provided in this respect in an embodiment of the method in accordance with the invention that the detection result contains the optical properties, especially the colour, light absorption, light transmission and fluorescence of the detected object, and/or the shape of the detected object and/or the material, especially the chemical composition of the detected object and/or the electrical properties of the detected object and/or the magnetic properties of the detected object and/or the electromagnetic properties of the detected object.

Electromagnetic properties shall especially be understood as all properties which are used in RFID (radio frequency identification) technology in order to enable the identification of objects which are provided with a transponder, which is also known as an RFID tag. It is also possible for example that objects with an RFID tag are located in the material stream and need to be sorted out. That is why a further preferred variant of the method in accordance with the invention provides that the detection results comprise all properties of the detected object which are utilised in the known RFID technology.

The object on which the invention is based will also be achieved in such a way that in an apparatus for sorting out interfering objects in a material stream made of acceptable material, preferably cullet, at least one blowing apparatus with at least one blowing opening is provided, a detection apparatus and separate room areas or containers, preferably shafts, for receiving or transferring the interfering objects or the acceptable material, wherein a fluid flow, preferably consisting of compressed air, can continuously be blown from the at least one blowing apparatus in the direction of the material stream within a separating chamber, and means are provided for the temporally and locally interruption of the fluid flow on the basis of a detection result of the detection apparatus, which means that the apparatus is configured in such a way that the fluid flow can be blown continuously or without interruption from the blowing apparatus.

It is provided according to a preferred embodiment that the separation chamber is arranged upstream of the separate room areas or containers, preferably the shafts.

Valves are provided as means for the temporal and local interruption of the fluid flow in order to interrupt the fluid flow by the blowing apparatus in a purposeful manner. In the blowing method known from the state of the art, NC valves (“normally closed”, i.e. closed without current) are usually used which will activate the fluid flow. The use of such NC valves in the apparatus in accordance with the invention would lead to the consequence that they would be virtually permanently activated in order to ensure continuous or constant blowing of a fluid flow from the blowing apparatus, which with respect to wear and tear as well as durability is not desirable. Assuming that the NC valves need to be kept open during continuous blowing by means of applied current, this would not only lead to high power consumption but also to a respectively high development of heat. This would lead to the consequence on the one hand that cooling of the valves (possibly even an active one) would have to be provided. On the other hand, the development of heat would impose limits on the achievable packing density, i.e. the minimum spacing of the valves from each other, because a specific, relatively large minimum distance would have to be maintained in order to exclude functional impairments by mutual influence of heat. It is therefore better to use NO valves (“normally open”, i.e. open without current) which will only be actuated for interrupting the fluid flow. Excessive heat development will therefore not pose any problem, which is why no special cooling measures need to be provided. Furthermore, a high packing density of the valves can be achieved because they are not limited by a minimum distance due to heat development. That is why a preferred embodiment of the apparatus in accordance with the invention provides that the means of interrupting the fluid flow comprise at least one NO valve.

The pressure of the fluid flow which is measured directly on the at least one blowing opening shall be understood as the blowing pressure. It is provided in a preferred embodiment of the apparatus in accordance with the invention that a blowing pressure of the fluid flow measured at the at least one blowing opening is substantially constant over time.

In order to subject the material stream to blowing in a homogeneous manner over its entire width, it is further provided that a blowing pressure of fluid flow measured at the at least one blowing opening is substantially identical at all blowing openings.

This apparatus allows a spatial separation of assortments of material with high and low or middle weights per unit area for example in a material stream. It can concern a material stream that falls down a drop section or one that is transported by means of a link conveyor. It is important that the drop section or the link conveyor leads through a separation chamber. That is why a drop section for a material stream is provided according to a preferred embodiment of the apparatus in accordance with the invention which extends through the separation chamber.

A link conveyor for the transport of the material stream is provided in an alternative embodiment of the apparatus in accordance with the invention, said link conveyor extending through the separation chamber. The objects of the material stream disposed on the link conveyor are blown through the gaps of the link conveyor.

It is provided according to a preferred embodiment of the apparatus in accordance with the invention that the detection apparatus is attached upstream of the at least one blowing apparatus.

A further embodiment of the apparatus in accordance with the invention provides a control unit which is connected to the detection apparatus and the blowing apparatus, and the control unit can evaluate both signals of the detection apparatus and also control the temporal and local interruption of the fluid flow by the blowing apparatus.

The sorting results that can be achieved by means of the apparatus in accordance with the invention can further be optimised by suitable selection of blowing pressure and quantity of the fluid flow, preferably the compressed air. That is why it is provided in a further embodiment of the apparatus in accordance with the invention that the control unit can control the blowing pressure and the quantity of the fluid flow that can be blown by the blowing apparatus.

### BRIEF DESCRIPTION OF THE DRAWINGS

The invention will now be explained in closer detail by reference to two embodiments. The drawings are exemplary and shall explain the inventive idea, but shall not limit the inventive idea in any way or finally represent the same, wherein:

FIG. 1 shows the diagram of a sorting method plus apparatus according to the state of the art, wherein the material flow to be sorted consists of two types of material;

FIG. 2 shows a location-time diagram of the blowing process according to the state of the art as shown in FIG. 1;

FIG. 3 shows the diagram of a sorting method plus apparatus in accordance with the invention, wherein the material stream to be sorted consists of two types of material;

FIG. 4 shows the location-time diagram of the blowing process in accordance with the invention as shown in FIG. 3;

FIG. 5 shows the diagram of a sorting method plus apparatus in accordance with the invention, wherein the material stream to be sorted consists of three types of material;

FIG. 6 shows a blowing apparatus which can be used for the sorting method in accordance with the invention or in the apparatus in accordance with the invention.

### DETAILED DESCRIPTION OF THE PREFERRED EMBODIMENTS

FIG. 1 schematically shows a blowing method as known from the state of the art for sorting bulk material such as building waste or comminuted (shredded) waste electrical appliances or preferably waste glass or cullet. The bulk material consists of two types of material: good or acceptable material 1, which preferably concerns acceptable glass, i.e. recyclable cullet, and foreign matter or interfering objects 2 such as ceramic, stone or porcelain objects (CSP). Acceptable material 1 and interfering objects 2 form a material stream 13 which flows over a chute 3 which is preferably transparent. The identification of the objects of the material stream 13 occurs by means of a detection apparatus 14 which comprises a transmitter 4 and a receiver 6. The transmitter 4, which is situated behind the chute 3, transmits signals, preferably light rays 5, through the chute 3 and the material stream 13 onto the receiver 6, preferably a photocell with a lens system disposed in front of the same. The receiver 6 is connected to a control unit 7 which evaluates the signals, by means of which individual objects of the material stream 13 are identified. It is decided for example on the basis of the determined light transmission whether acceptable glass is concerned or a ceramic, stone or porcelain object (CSP). The control unit 7 can further also be connected to the transmitter 4 for this purpose in order to control the same for example or query information on the emitted signal. If an object is identified as an interfering object 2, a timely and locally correct compressed-air pulse will be switched via a blowing apparatus 8 which comprises at least one NC valve 25 and at least one blowing opening 22, producing a blowing out of the interfering object 2 once it has dropped to the end of the chute 3. This means that the interfering object 2, which falls down a drop section 16 from the chute, will be deflected from its usual path during its descent. The deflection occurs in a separation chamber 15 in which the compressed-air pulse will be placed via the blowing apparatus 8 and through which the drop section 16 leads. The trajectory 19 of the interfering object 2 ends thereupon in a container or a shaft, preferably a fraction shaft 10, and therefore no longer follows a drop parabola. If an object is identified as acceptable material 1, there will not be any blowing and the acceptable material 1 will fall from the chute 3 without deflection into another shaft, preferably a fraction shaft 9. In a multi-stage sorting process (not shown), the material disposed in the fraction shaft 9 would be transmitted to a further sorting stage.

In order to ensure that the interfering object 2 will actually be deflected by the compressed-air pulse, so-called overblowing will usually occur. In this process, the compressed-air pulse will not be switched in the moment in which the interfering object 2 passes the blowing apparatus 8, but already slightly earlier. Furthermore, the duration of the compressed-air pulse will typically be dimensioned in a generous manner in order to ensure the deflection of the interfering object. This means that the time interval in which compressed air is blown out by the blowing apparatus 8 in order to deflect the interfering object 2 will commence slightly earlier and will end slightly later than the time interval in which the interfering object 2 falls past the blowing apparatus 8. It is also attempted in this way to take into account differences in speed of the freely falling objects of the material stream 13.

The spatial interval of the compressed-air pulse will typically be slightly larger than the actual spatial expansion of the interfering object 2 in order to ensure the deflection of the interfering object 2. This also takes into account any possible deviations from the ideal path of movement of the interfering objects 2.

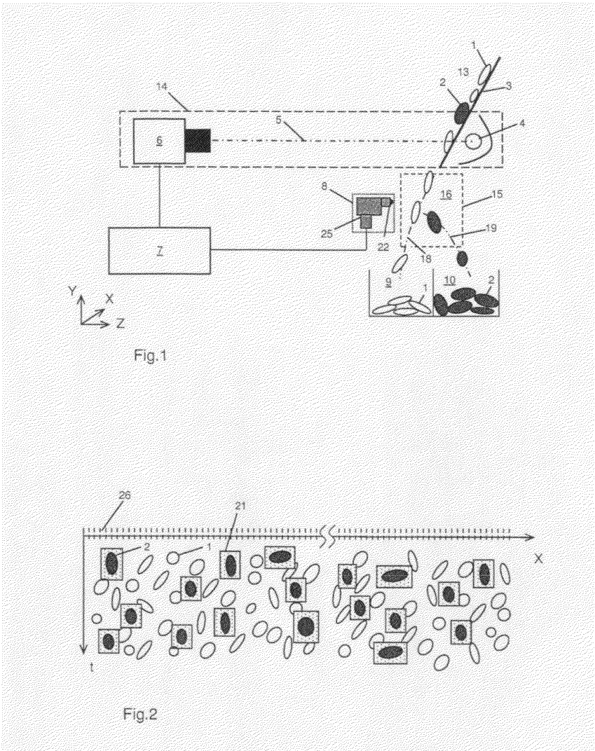

FIG. 2 illustrates this fact on the basis of a location-time diagram, in which the blowing process is shown in local and temporal resolution. Only one local dimension (the X direction) is shown for reasons of clarity of illustration, which dimension is determined in FIG. 1 by the system of coordinates indicated there (with X, Y and Z direction) and coincides with the direction of width of the material stream 13. This corresponds to the case for example where the blowing apparatus 8 consists of a blowing strip which contains a number of NC valves 25 with blowing openings 22 which are arranged in the X direction. In this respect, there are 80 NC valves 25 on a meter of width of the sorting or material stream and accordingly there are 80 valve tracks 26 which respectively correspond to the width of an NC valve 25, wherein at least one blowing opening 22 is arranged in each valve track 26. The diagram of FIG. 2 shows the X direction as the horizontal X axis. It is subdivided into valve tracks 26. The vertical t axis represents the time.

The spatial and temporal interval of blowing an interfering object 2 with compressed air is indicated in an action window 21, the area of which is shown with the dotted field. The interfering object 2 lies within this action window 21, wherein the sides of the action window 21 do not touch the interfering object 2, which means that the action window 21 not only comprises the interfering object 2 but also an edge, i.e. a certain spatial and temporal interval, around the interfering object 2. This is the diagrammatic illustration of the overblowing as described above. The expansion of the action window 21 or the overblowing leads to the consequence that as a result of the spatial and temporal proximity of the objects of the material stream 13 towards each other not only interfering objects 2 will be found in the action window 21 but also objects of the acceptable material 1 will protrude into the action window 21. This means that acceptable material objects will be influenced by compressed air pulses which were actually only intended for the interfering objects 2, as a result of which objects of the acceptable material 1 will partly be deflected to such an extent that their trajectories 18 will end in the fraction shaft 10. This explains why overblowing is typically accompanied by a high loss of acceptable material, i.e. a high fraction of erroneously sorted acceptable material 1.

The following numerical example will illustrate this on the basis of typical values: the material stream 13 to be sorted consists of 1000 kg of cullet with 50,000 ppm of interfering object fraction, i.e. there are 950 kg of acceptable material 1 and 50 kg of interfering objects 2 in the material stream 13. A degree of purity of 97% leads to the consequence that 48.5 kg of interfering objects 2 will end up in the fraction shaft 10 and 1.5 kg in the fraction shaft 9. A loss of accepted material of 25% leads to 237.5 kg of erroneously sorted acceptable material 1 in the fraction shaft 10. Accordingly, only 712.5 kg of acceptable material 1 will end up in the fraction shaft 9, which means the interfering object fraction is approximately 2100 ppm after the sorting process. At a fraction of interfering objects of 25 ppm at most, which is still accepted by glassworks for example for supplied cullet for recycling, this means that four sorting steps are necessary (i.e. sorting apparatuses that are switched behind one another) in order to meet the predetermined quality requirements.

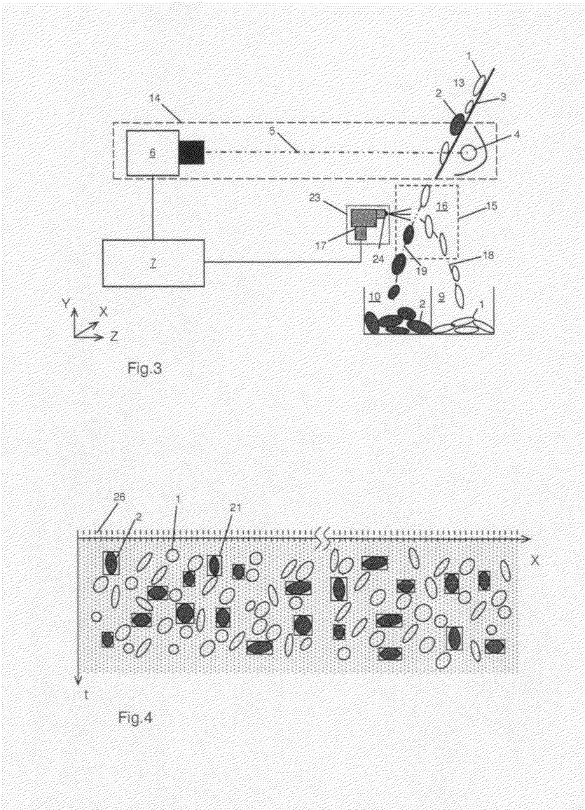

FIG. 3 illustrates an embodiment of the method in accordance with the invention which ensures a high degree of purity and simultaneously achieves lower losses of acceptable material. The bulk material which consists of two types of material (acceptable material 1, preferably useful glass, and interfering objects 2, e.g. ceramic, stone or porcelain objects (CSP)) flows as a material stream 13 over a chute 3 which is preferably transparent. The material flow 13 will drop down a drop section 16 at the end of the chute 3.

In contrast to the known blowing method, the material stream 13 will be blown continuously via a blowing apparatus 23 which consists of a blowing strip for example. For this purpose, compressed air is blown continuously (without interruption) into a separation chamber 15 from the blowing apparatus 23 from at least one blowing opening 24 relating to the sorting process. The blowing pressure of the compressed air is substantially constant over time. The drop section 16 of the material stream 13 leads through the separation chamber 15, so that the material stream 13 will be subjected to blowing when falling through the separation chamber 15, with the blowing pressure (i.e. the pressure measured at the at least one blowing opening 24) being substantially constant over the width of the material stream 13.

The continuous blowing already leads to a certain sorting effect because interfering objects 2 which are heavy or have a high weight unit area and/or an unfavourable geometry such as stones or CSP for example will hardly be deflected from their normal trajectory, which means the trajectories 19 of the interfering objects 2 with a high weight per unit area will hardly deviate in any case from a drop parabola. Acceptable material 1 on the other hand, which has an average weight unit area, is provided with a distinct deflection by the continued blowing, which means the trajectories 18 of the individual acceptable material objects with average weight unit area will clearly deviate from a drop parabola after falling through the separation chamber 15.

Final sorting will be achieved in that the air stream by the blowing apparatus 23 will briefly be interrupted at the correct point in time when an object has been identified as an interfering object 2.

The identification occurs by means of a detection apparatus 14 which comprises a transmitter 4 and a receiver 6. The transmitter 4, which is situated behind the chute 3, transmits signals, preferably light rays 5, through the chute 3 and the material stream 13 onto the receiver 6, preferably a photocell with a lens system disposed in front of the same. The receiver 6 is connected to a control unit 7 which evaluates the signals, by means of which individual objects of the material stream 13 will be identified. It will be decided on the basis of the determined light transmission for example whether the material concerns useful glass or a ceramic, stone or porcelain objects (CSP). For this purpose, the control unit 7 can also be connected to the transmitter 4 in order to control the same for example or query information on the emitted signal.

The interruption of the air stream preferably occurs by means of NO valves 17 (“normally open”, i.e. open without current) which interrupt the air stream when triggered. Furthermore, the air stream can be interrupted not only temporally but also locally in a correct manner depending on the configuration of the blowing apparatus 23, which means the air stream will then not be interrupted over the entire width of the blowing apparatus 23 and therefore over the entire width of the material stream 13, but only over a specific section of the blowing apparatus 23 and therefore only over a specific area of the material stream 13 which was associated with the identified object by the control unit 7. As a result, the interfering objects 2 will not be deflected in a purposeful manner in their drop section 16 and will therefore reach in a virtually unobstructed way a container or a shaft, preferably a fraction shaft 10, provided for the interfering objects 2. Acceptable material 1 on the other hand will be deflected in its drop section 16 in the separation chamber 15 and will thereupon end up in another container or shaft, preferably a fraction shaft 9.

The sorting effect can be optimised by the precise positioning of the blowing apparatus 23 and by specific configuration of the geometry of the separation chamber 15. Further optimisation occurs by suitable selection of the blowing pressure and the quantity of compressed air, especially depending on the material to be sorted, wherein this can be controlled ideally via the control unit 7, which again ensures simple adjustment of the system and high operational stability.

In contrast to the known blowing methods like the one shown in FIG. 1, the method in accordance with the invention allows that the blowing pressure of the compressed air can be considerably lower than the respective blowing pressure on the one hand, and the compressed air quantity per unit of time will remain approximately constant or will even decrease with a higher fraction of interfering objects on the other hand. In contrast to the aforementioned known blowing method (see FIG. 1) where usually blowing pressures of approximately 6 bars are used, the method in accordance with the invention typically works with 2.5 to 4.0 bars, especially preferably 3.5 bars, by means of which the total consumption of compressed air will be substantially lower. A nominal volume flow of compressed air of approximately 400 Nm³/h (i.e. 400 m³/h under normal conditions) are required for the sorting out of 3 t of cullet with the known blowing method per metre of material stream width. In this process, an NC valve 25 will perform up to 1000 switching processes per minute under nominal feed performance. In contrast to this, up to 15 t of cullet can be sorted out with the method in accordance with the invention with approximately 400 Nm³/h of compressed air, which means in comparison with known blowing methods the method in accordance with the invention also allows a higher feed performance, which is why fewer sorting apparatuses need to be operated in parallel in combination with the same sorting quantity. An NO valve 17 only performs up to 150 switching processes per minute at a fraction of 5% of interfering objects for example. It is understood that the main air supply will be interrupted when no material to be sorted will reach the apparatus, e.g. during a break or standstill of the installation.

Moreover, very high degrees of purity of more than 99% in combination with low losses of acceptable material are achieved with the method in accordance with the invention. The substantially lower loss of acceptable material in comparison with methods such as the one shown in FIG. 1 which relates to the location-distance diagram shown in FIG. 2 is clearly shown by means of the location-distance diagram of the method in accordance with the invention as shown in FIG. 4. As in FIG. 2, FIG. 4 only shows one local dimension (the X direction) for reasons of clarity of the illustration, which is determined in FIG. 3 by the system of coordinates (with X, Y and Z direction) as indicated there and coincides with the width direction of the material stream 13. This corresponds to the case for example where the blowing apparatus 23 consists of a blowing strip which contains a number of NO valves 17 arranged in the X direction and comprising blowing openings 24. In this respect, there are 80 NO valves 17 on a metre of width of the sorting or material stream, and accordingly there are 80 valve tracks which respectively correspond to the width of an NO valve 17, wherein at least one blowing opening 24 is arranged in each valve track 26.

FIG. 6 illustrates the configuration of such a blowing apparatus 23 with NO valves 17, with one blowing opening 24 being provided per valve track 26. Two or three blowing openings 24 per valve track 26 can also be regarded as typical.

In the diagram of FIG. 4, the X direction is entered as the horizontal X axis. It is divided into valve tracks 26. The vertical t axis represents the time.

The dotted background surface corresponds to continuous blowing of the material stream 13, which consists of the acceptable material 1 and the interfering objects 2. The action windows 21 are marked now by the spatial and temporal interval of the interruption of the air stream. The area of the action window 21 is accordingly not shown in a dotted manner but in white. The interfering objects 2 respectively lie within an action window 21, wherein the sides of the action window 21 substantially touch the respective interfering object 2 at least in the t direction, which means the action window 21 substantially only comprises the interfering object 2, at least in the temporal direction. In other words, the time interval in which the air stream from the blowing apparatus 23 is interrupted is substantially congruent with the time interval in which the interfering object 2 drops past the blowing apparatus 23. A typical time interval would be 30 ms which is obtained for an interfering object 2 with a length of 45 mm and a speed of 1.5 m/s (as respectively measured in the direction of the drop section 16). It would even be possible to choose this interval slightly smaller. An excessively long interruption of the air stream which corresponds to overblowing in the known blowing method will not occur in any case in the sorting method in accordance with the invention. This is possible because a certain sorting effect will occur even without the interruption of the air stream where interfering objects 2 which are mostly heavy or have a high weight per unit area and/or an unfavourable geometry are hardly deflected from the normal trajectory. Only objects of the material flow 13 which have an average weight per unit area will be deflected in the drop section 16 in the separation chamber 15.

For this reason, the spatial intervals in which the air stream is interrupted around the interfering objects 2 can be chosen in a shorter manner than is possible in the conventional method. That is why the sides of the action window 21 in FIG. 4 are also closer in the (spatial) X direction to the interfering objects 2 than is the case in FIG. 2.

Consequently, virtually no objects of the acceptable material 1 will protrude into the action window 21 even in the case of high coverage density of the material stream 13. This means that the acceptable material objects are virtually not affected at all by the interruption of the air stream. Instead, they will substantially always be subjected to blowing and deflected, which is why their trajectories 18 will always end in the fraction shaft 9 provided for the acceptable material 1. This leads to a substantially lower loss of acceptable material, which is substantially lower than in the blowing method as known from the state of the art.

The following numerical example will illustrate this, especially in comparison with the example provided above for the known blowing method: the material stream 13 to be sorted consists again of 1000 kg of cullet with 50,000 ppm of interfering object fraction, i.e. there are 950 kg of acceptable material 1 and 50 kg of interfering objects 2 in the material stream 13. A degree of purity of 99% leads to the consequence that 49.5 kg of interfering objects 2 will end up in the fraction shaft 10 and 0.5 kg in the fraction shaft 9. A loss of accepted material of 10% leads to 95 kg of acceptable material 1 erroneously sorted out in the fraction shaft 10. Accordingly, 855 kg of acceptable material 1 will end up in the fraction shaft 9, which means the interfering object fraction is close to 600 ppm after the sorting process, which is why fewer sorting steps need to be used in order to achieve a predetermined degree of purity. It will become immediately clear when the 600 ppm of interfering object fraction is compared with the interfering object fraction of a maximum of 25 ppm which will still be accepted by glassworks by supplied cullet for recycling and the 2100 ppm interfering object fraction which is typically achieved by the known blowing method (see above).

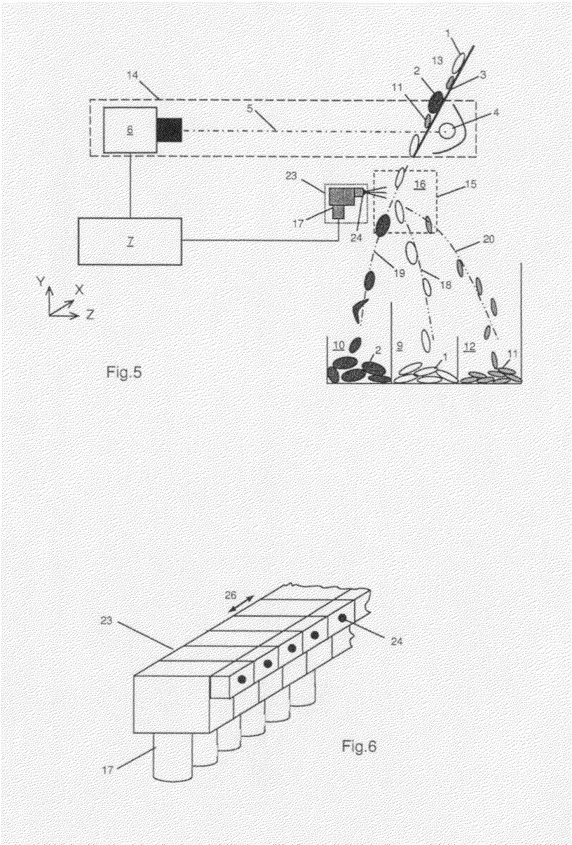

FIG. 5 shows a further embodiment of the method in accordance with the invention which differs from the variant as shown in FIG. 3 in such a way in particular that the material stream 13 is composed of three types of material. The bulk material flows as a material stream 13 again over a preferably transparent chute 3 from which the material flow 13 subsequently drops down a drop section 16. The material stream 13 consists of acceptable material 1, preferably useful glass with an average weight per unit area, interfering objects 2 which are also heavier or have a high weight per unit area and/or an unfavourable geometry such as stones or beer stoppers, and preferably organic interfering objects 11 which have a low weight per unit area such as labels for example.

The material stream 13 will be subjected to continuous blowing via a blowing apparatus 23 which consists of a blowing strip for example. For this purpose, compressed air is blown continuously (without interruption) into a separation chamber 15 from the blowing apparatus 23 from at least one blowing opening 24. The blowing pressure of the compressed air is substantially constant over time. The drop section 16 of the material stream 13 leads through the separation chamber 15, so that the material stream 13 will be subjected to blowing when falling through the separation chamber 15, with the blowing pressure being substantially constant over the width of the material stream 13.

The continuous blowing already leads to a certain sorting effect because interfering objects 2, which are mostly heavy or have a high weight unit area and/or an unfavourable geometry such as stones or beer stoppers for example, will hardly be deflected from their normal trajectory, which means the trajectories 19 of the such interfering objects 2 will hardly deviate in any case from a drop parabola. Acceptable material 1 on the other hand, which has an average weight unit area, is provided with a distinct deflection by the continued blowing, which means the trajectories 18 of such acceptable material objects will clearly deviate from a drop parabola after falling through the separation chamber 15. Preferably organic interfering objects 11 which have a low weight per unit area will be deflected extremely, which is why their trajectories 20 will deviate very distinctly from a drop parabola.

Final sorting will be achieved in that the air stream by the blowing apparatus 23 will briefly be interrupted at the correct point in time when an object has been identified as an interfering object 2.

The identification occurs by means of a detection apparatus 14 which comprises a transmitter 4 and a receiver 6. The transmitter 4 which is situated behind the chute 3 transmits signals, preferably light rays 5, through the chute and the material stream 13 onto the receiver 6, preferably a photocell with a lens system disposed in front of the same. The receiver 6 is connected to a control unit 7 which evaluates the signals, by means of which individual objects of the material stream 13 will be identified. It will be decided on the basis of the determined light transmission for example whether the material concerns useful glass or a ceramic, stone or porcelain objects (CSP). For this purpose, the control unit 7 can also be connected to the transmitter 4 in order to control the same for example or query information on the emitted signal.

The interruption of the air stream preferably occurs by means of NO valves 17 which interrupt the air stream when triggered. Furthermore, the air stream can be interrupted not only temporally but also locally in a correct way, depending on the configuration of the blowing apparatus 23, which means the air stream will then not be interrupted over the entire width of the blowing apparatus 23 and therefore over the entire width of the material stream 13, but only over a specific section of the blowing apparatus 23 and therefore only over a specific area of the material stream 13 which was associated with the identified object by the control unit 7. As a result, the interfering objects 2 will not be deflected in a purposeful manner in their drop section 16 and will therefore reach in a virtually unobstructed way a container or a shaft, preferably a fraction shaft 10, provided for the interfering objects 2. Acceptable material 1 on the other hand which has an average weight per unit area will distinctly be deflected in its drop section 16 in the separation chamber 15 and will thereupon end up in another container or shaft provided for the acceptable material 1, preferably a fraction shaft 9. The preferably organic interfering objects 11 which have a low weight per unit area will be deflected very distinctly or extremely in their drop section 16 in the separation chamber 15 and will drop into a further container or a further shaft, preferably a fraction shaft 12, provided for these interfering objects 11.

The sorting effect can be optimised by the precise positioning of the blowing apparatus 23 and by specific configuration of the geometry of the separation chamber 15. Further optimisation occurs by suitable selection of the blowing pressure and the quantity of compressed air, especially depending on the material to be sorted, wherein this can be controlled ideally via the control unit 7, which again ensures simple adjustment of the system and high operational stability.

In contrast to the known blowing methods like the one as shown in FIG. 1, this embodiment of the method in accordance with the invention also allows that the blowing pressure of the compressed air can be considerably lower than the respective blowing pressure on the one hand, and the compressed air quantity per unit of time will remain approximately constant or will even decrease with a higher fraction of interfering objects on the other hand. In contrast to the aforementioned known blowing method (see FIG. 1) where usually blowing pressures of approximately 6 bars are used, the method in accordance with the invention typically works with typically approx. 3.5 bars, by means of which the total consumption of compressed air will be substantially lower. A nominal volume flow of compressed air of approximately 400 Nm³/h (i.e. 400 m³/h under normal conditions) are required for the sorting out of 3 t of cullet with the known blowing method per metre of material stream width. In this process, an NC valve 25 will perform up to 1000 switching processes per minute under nominal feed performance. In contrast to this, up to 15 t of cullet can be sorted out with the method in accordance with the invention with approximately 400 Nm³/h of compressed air, which means in comparison with known blowing methods the method in accordance with the invention also allows higher feed performance, which is why fewer sorting apparatuses need to be operated in parallel in combination with the same sorting quantity. An NO valve 17 only performs up to 150 switching processes per minute at an interfering object fraction of 5% for example. It is understood that the main air supply will be interrupted when no material to be sorted will reach the apparatus, e.g. during a break or standstill of the installation.

Moreover, very high degrees of purity of more than 99% in combination with low losses of acceptable material are achieved with the method in accordance with the invention. The substantially lower loss of acceptable material in comparison with methods such as the one shown in FIG. 1 which relates to the location-distance diagram shown in FIG. 2 can be explained in complete analogy to the method in accordance with the invention for the sorting of a material stream 13 consisting of two types of material (see FIG. 4 and the explanations above in connection with this drawing).

In order to achieve optimal results in sorting with the method in accordance with the invention, it has proven to be advantageous to ensure by means of preliminary sorting that the material stream 13 actually substantially only consists of only so many types of material (two (see FIG. 3) and three (see FIG. 5) in the embodiments as explained above) which will subsequently be separated or sorted in accordance with the invention.

### Alternative Embodiment of the Invention

In alternative embodiments of the method in accordance with the invention, as schematically shown in FIG. 3 and FIG. 5, alternative transmitters and receivers or sensors can be used for the detection or identification of the objects. Accordingly, other criteria can be used for the interruption of the air stream depending on the employed transmitter and/or receiver or sensor. This includes the interruption of the air stream depending on the optical properties, especially the colour, light absorption, light transmission and fluorescence of the detected object, and/or the shape of the detected object and/or the material, especially the chemical composition of the detected object and/or the electrical properties of the detected object and/or the magnetic properties of the detected object and/or the electromagnetic properties of the detected object. Electromagnetic properties shall especially be understood as all properties which are used in RFID (radio frequency identification) technology in order to enable the identification of objects which are provided with a transponder (also known as an RFID tag). It is also possible for example that objects with an RFID tag are located in the material stream 13 and need to be sorted out.

### LIST OF REFERENCE NUMERALS

1 Acceptable material
2 Interfering objects
3 Chute
4 Transmitter
5 Light rays
6 Receiver
7 Control unit
8 Blowing apparatus
9 Fraction shaft for the acceptable material
10 Fraction shaft for interfering objects
11 Organic interfering objects
12 Fraction shaft for organic interfering objects
13 Material stream
14 Detection apparatus
15 Separation chamber
16 Drop section
17 NO valve
18 Trajectory of an acceptable material object
19 Trajectory of an interfering object
20 Trajectory of an organic interfering object
21 Action window
22 Blowing opening
23 Blowing apparatus
24 Blowing opening
25 NC valve
26 Valve track

1-16. (canceled)

17: A method for sorting out interfering objects (2, 11) in a material stream (13) made of acceptable material (1), preferably cullet, wherein the interfering objects (2, 11) and the acceptable material (1) are respectively sorted during a sorting process in at least one separate room area or a container, preferably a shaft (9, 10, 12), wherein the material stream (13) is continuously subjected during a sorting process to a fluid flow having a blowing pressure, preferably compressed air, wherein the fluid flow is interrupted temporally and/or locally depending on a detection result of a detecting apparatus (14) which detects the interfering objects in the material stream (13).

18: A method according to claim 17, wherein the material stream (13) is subjected to blowing during its free fall.

19: A method according to claim 17, wherein the blowing pressure of the fluid flow is temporally substantially constant.

20: A method according to claim 17, wherein the blowing pressure of the fluid flow is substantially constant over the width of the material stream (13).

21: A method according to claim 17, wherein the detection result contains the optical properties, especially the color, light absorption, light transmission and fluorescence of the detected object, and/or the shape of the detected object, and/or the material, especially the chemical composition of the detected object, and/or the electrical properties of the detected object, and/or the magnetic properties of the detected object, and/or the electromagnetic properties of the detected object.

22: A method according to claim 21, wherein the detection result comprises all properties of the detected object which are utilized in the known RFID technology.

23: An apparatus for performing a method according to claim 17 for sorting out interfering objects (2, 11) in a material stream (13) made of acceptable material (1), preferably cullet, comprising a detecting apparatus (14) and separate room areas or containers, preferably shafts (9, 10, 12), for receiving or transferring the interfering objects (2, 11) or the acceptable material (1), wherein at least one blowing apparatus (23) with at least one blowing opening (24) is provided in order to blow a fluid flow, preferably consisting of compressed air, continuously in the direction of the material stream (13) within a separating chamber (15), and wherein means are provided for the temporal and local interruption of the fluid flow on the basis of a detection result of the detection apparatus (14).

24: An apparatus according to claim 23, wherein the separating chamber (15) is arranged upstream of the separate room areas or containers, preferably the shafts (9, 10, 12).

25: An apparatus according to claim 23, wherein the means for interrupting the fluid flow comprise at least one NO (“normally open”) valve (17).

26: An apparatus according to claim 23, wherein a drop section (16) is provided for the material stream (13) which extends through the separating chamber (15).

27: An apparatus according to claim 23, wherein a link conveyor is provided for the transport of the material stream (13), which link conveyor extends through the separating chamber (15).

28: An apparatus according to claim 23, wherein the detection apparatus (14) is attached upstream of the at least one blowing apparatus (23).

29: An apparatus according to claim 23, wherein a control unit (7) is provided, which is connected to the detection apparatus (14) and the blowing apparatus (23), and the control unit (7) can evaluate both signals of the detection apparatus (14) and can also control the temporal and local interruption of the fluid flow by the blowing apparatus (23).

30: An apparatus according to claim 29, wherein the blowing pressure and the quantity of the fluid flow that can be blown through the blowing apparatus (23) can be controlled by the control unit (7).
